(19) United States
(12) Patent Application Publication
(10) Pub. No.: US 2025/0306051 A1
(43) Pub. Date: Oct. 2, 2025

(54) DUAL CHANNEL SIPPER ASSEMBLIES AND RELATED INSTRUMENTS AND METHODS

(71) Applicant: ILLUMINA, INC., San Diego, CA (US)

(72) Inventor: Sze Ang, Singapore (SG)

(21) Appl. No.: 18/851,593

(22) PCT Filed: Dec. 15, 2023
(86) PCT No.: PCT/US2023/084190

§ 371 Date: Sep. 26, 2024

Related U.S. Application Data
(60) Provisional application No. 63/434,825, filed on Dec. 22, 2022.

(51) Int. Cl. G01N 35/10; B01L 3/00

(52) U.S. Cl. CPC G01N 35/1002; B01L 3/523; G01N 35/1079; B01L 2200/16; B01L 2300/044

(57) ABSTRACT

Dual channel sipper assemblies and related methods are disclosed. A reagent assembly for a sequencing platform includes a reagent cartridge having a first container including a container body and an open end. The container body defines a reagent chamber containing a liquid reagent. A cover is disposed over the open end and the cover includes a pressure and reagent port fluidly coupled to the reagent chamber. A sipper is adapted for piercing the cover of the reagent cartridge through the pressure and reagent port to both pressurize the reagent chamber and to aspirate liquid reagent from the reagent chamber. The sipper includes a first lumen and a second lumen. The first lumen is to deliver pressurized fluid to the reagent chamber. The second lumen is to aspirate liquid reagent from the reagent chamber.

### RELATED APPLICATION

This application claims the benefit of and priority to U.S. Provisional Patent Application No. 63/434,825, filed Dec. 22, 2022, the content of which is incorporated by reference herein in its entirety and for all purposes.

### BACKGROUND

Reagent cartridges may be used with, for example, sequencing platforms. The sequencing platforms may use sipper assemblies to flow reagent from the reagent cartridges.

### SUMMARY

Shortcomings of the prior art can be overcome and advantages and benefits as described later in this disclosure can be achieved through the provision of dual channel sipper assemblies and related methods. Various implementations of the apparatus and methods are described below, and the apparatus and methods, including and excluding the additional implementations enumerated below, in any combination (provided these combinations are not inconsistent), may overcome these shortcomings and achieve the advantages and benefits described herein.

In accordance with a first implementation, an apparatus includes a reagent cartridge and a system. The reagent cartridge including a first container having a container body and an open end. The container body defining reagent chamber containing a liquid reagent, and a cover disposed over the open end. The system including a receptacle and a sipper assembly. The receptacle to receive the reagent cartridge. The sipper assembly for piercing the cover of the reagent cartridge to both pressurize the reagent chamber and to aspirate liquid reagent from the reagent chamber. The sipper assembly includes a first lumen and a second lumen, the first lumen delivering pressurized fluid to the reagent chamber and the second lumen aspirating liquid reagent from the reagent chamber.

In accordance with a second implementation, an apparatus includes a receptacle for receiving a reagent cartridge. A sipper assembly pierces a cover of the reagent cartridge to both pressurize a reagent chamber and to aspirate liquid reagent from the reagent chamber. The sipper assembly includes a first lumen and a second lumen, the first lumen delivering pressurized fluid to the reagent chamber and the second lumen aspirating liquid reagent from the reagent chamber.

In accordance with a third implementation, a method includes piercing a pressure and aspiration port of a reagent cartridge with a sipper assembly. The sipper assembly includes a first lumen and a second lumen. The method also includes delivering a pressurized fluid to a reagent chamber through the first lumen and aspirating liquid reagent from the reagent chamber through the second lumen.

In accordance with a fourth implementation, an apparatus includes a sipper assembly including a first lumen and a second lumen. The first lumen is to deliver pressurized fluid to a chamber and the second lumen is to aspirate liquid from the chamber.

In accordance with a fifth implementation, a method includes piercing a pressure and aspiration port of a reagent chamber of a reagent cartridge with a sipper assembly. The sipper assembly includes a first lumen and a second lumen. The method also includes delivering a pressurized fluid to the reagent chamber of the reagent cartridge through the first lumen. The first lumen has a pressurization exit, the pressurization exit being located above a level of liquid reagent in the reagent chamber. The method includes aspirating liquid reagent from the reagent chamber through the second lumen. The second lumen has an aspiration inlet, the aspiration inlet being located below the level of liquid reagent in the reagent chamber.

In further accordance with the foregoing first, second, third, fourth, and/or fifth implementations an apparatus and/or method may further include or comprise any one or more of the following:

In an implementation, the cover includes a pressure and reagent port fluidly coupled to the reagent chamber and the sipper assembly pierces the cover through the pressure and reagent port.

In an implementation, a source of pressurized fluid is fluidly connected to the first lumen.

In an implementation, the first lumen is shorter than the second lumen.

In an implementation, the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into the container body through the cover.

In an implementation, the first lumen has a pressurization exit and the second lumen has an aspiration inlet, the pressurization exit being located above a level of liquid reagent in the reagent chamber and the aspiration inlet being located below a level of liquid reagent in the reagent chamber, when the sipper assembly is completely inserted into the container body through the cover.

In an implementation, the first lumen includes a pressurization inlet, and the first lumen includes an approximately 90 degree bend between the pressurization inlet and the pressurization exit.

In an implementation, the sipper assembly includes a chamfered distal end.

In an implementation, the aspiration inlet is located proximate the chamfered distal end.

In an implementation, the cover comprises foil.

In an implementation, the cover comprises a septum.

In an implementation, the pressurization exit is substantially perpendicular to a longitudinal axis of the sipper assembly.

In an implementation, the pressurization exit is substantially parallel to a longitudinal axis of the sipper assembly.

In an implementation, a reagent fluid is disposed in the reagent chamber.

In an implementation, a fluidic interface is fluidly connected to the sipper assembly and is fluidly coupled to a flow cell.

In an implementation, delivering the pressurized fluid to the reagent chamber through the first lumen comprises delivering gas to the reagent chamber through the first lumen.

In an implementation, delivering the pressurized fluid to the reagent chamber through the first lumen comprises delivering gas to the reagent chamber through the first lumen within a headspace of the reagent cartridge.

In an implementation, the first lumen and the second lumen are integral.

In an implementation, the first lumen has a first opening and the second lumen has an opening, and wherein piercing the pressure and aspiration port of the reagent cartridge with the sipper assembly comprises positioning the first opening of the first lumen within a headspace of the reagent chamber and comprises positioning the second opening of the second lumen within the liquid reagent.

In an implementation, the first lumen has an opening and the second lumen has an opening, the opening of the first lumen to be positioned within a headspace of a container, the opening of the second lumen to be positioned within the liquid.

In an implementation, delivering the pressurized fluid to the reagent chamber through the first lumen comprises delivering air to the reagent chamber through the first lumen.

In an implementation, delivering the pressurized fluid to the reagent chamber through the first lumen comprises delivering inert gas to the reagent chamber through the first lumen.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a perspective view of a cartridge and sipper assembly constructed in accordance with the teachings of this disclosure.

FIG. 3 is a side cut-away view of the cartridge and sipper assembly of FIG. 2.

FIG. 4 is a perspective view of the sipper of the cartridge and sipper assembly of FIG. 2.

FIG. 5 is a perspective cut-away view of the sipper of FIG. 4, illustrating a first lumen.

FIG. 6 is another perspective cut-away view of the sipper of FIG. 4, illustrating a second lumen.

FIG. 7 is a perspective view of an alternate implementation of the sipper of FIG. 4.

FIG. 8 illustrates a method of aspirating a reagent in accordance with the teachings of this disclosure.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

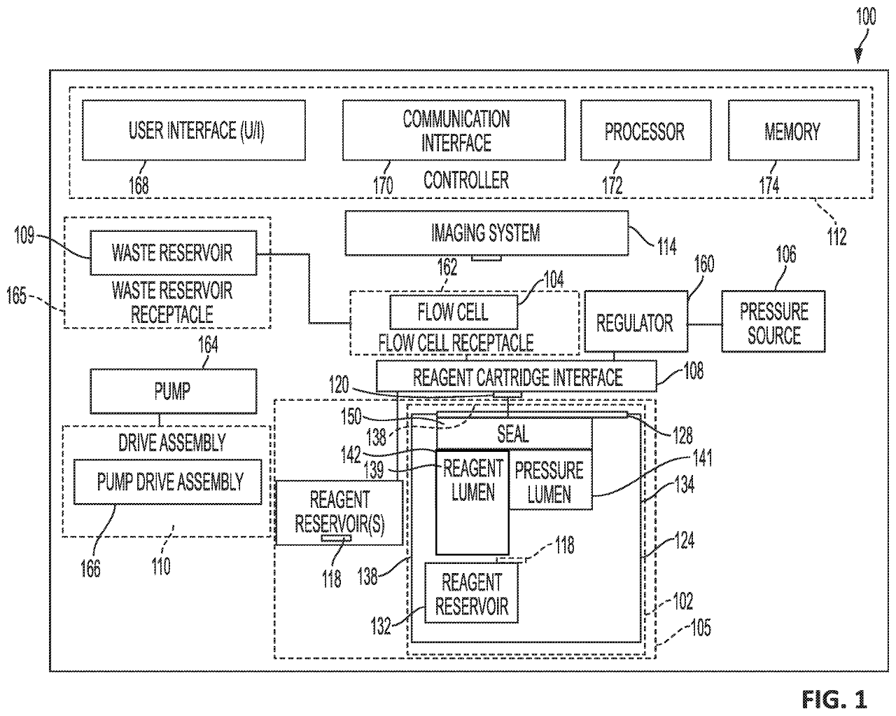

FIG. 1 illustrates a schematic diagram of an implementation of an example system 100. The system 100 can be used to perform an analysis on one or more samples of interest. For example, the sample may include one or more DNA clusters that are linearized to form a single stranded DNA (sstDNA). In the example illustrated, the system 100 receives a reagent cartridge 102 and a flow cell 104 and includes, in part, a reagent cartridge receptacle 105, a pressure source 106, a reagent cartridge interface 108, a drive assembly 110, a controller 112, an imaging system 114, a waste reservoir 116, and a sipper assembly 142. As used herein, a “flow cell” can include a device having a lid extending over a reaction structure to form a flow channel therebetween that is in communication with a plurality of reaction sites of the reaction structure, and can include a detection device that detects designated reactions that occur at or proximate to the reaction sites. The reagent cartridge 102 may alternatively be referred to as a reagent assembly or a reagent reservoir. The reagent cartridge 102 may be implemented by a container having flexible sides and/or may be implemented by a more rigid container.

The reagent cartridge 102 contains reagent 118 in the example shown and the reagent cartridge receptacle 105 receives the reagent cartridge 102. The reagent 118 may be liquid reagent. The reagent 118 may alternatively be a dried reagent that may be rehydrated by flowing hydrating liquid into the reagent cartridge 102 for example. The reagent cartridge interface 108 has a reagent and pressure coupling 120 fluidly coupled to the pressure source 106 and to the flow cell 104. The controller 112 is electrically and/or communicatively coupled to the pressure source 106, the reagent cartridge interface 108, the drive assembly 110, and the imaging system 114, and causes the pressure source 106, the reagent cartridge interface 108, the drive assembly 110, and/or the imaging system 114 to perform various functions as disclosed herein.

The flow cell 104 carries a sample of interest. The sipper assembly 142 may be used to pierce the reagent cartridge 102 and the pressure source 106 and the sipper assembly 142 may be used to pressurize the reagent cartridge 102 to flow the reagent 118 from the reagent cartridge 102 to interact with the sample. The pressure source 106 may be provided by the system 100 and/or may be carried by the reagent cartridge 102.

In one example, a reversible terminator may be attached to the reagent to allow a single nucleotide to be incorporated onto a growing DNA strand. One or more of the nucleotides has a unique fluorescent label that emits a color when excited in some implementations. The color (or absence thereof) is used to detect the corresponding nucleotide. The imaging system 114 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 114 may be a fluorescence spectrophotometer including an objective lens and/or a solid-state imaging device. The solid-state imaging device may include a charge coupled device (CCD) and/or a complementary metal oxide semiconductor (CMOS).

Another reaction component (e.g., a reagent) is flowed into the flow cell 104 after the image data is obtained and is thereafter received by the waste reservoir 109 and/or otherwise exhausted by the reagent cartridge 102. The reaction component may perform a flushing operation that chemically cleaves the fluorescent label and the reversible terminator from the sstDNA. The sstDNA is then ready for another cycle.

The reagent cartridge 102 may include a rigid or flexible container 124 and includes a coupling, such as a lid 128 in the implementation shown. The rigid or flexible container 124 may be referred to as a reagent reservoir. The rigid or flexible container 124 defines an interior 132 that contains the reagent 118.

In the implementation shown, the lid 128 has a pressure and reagent port 138 formed therein and fluidly coupled to the interior of the rigid or flexible container 124. The pressure and reagent port 138 forms an access point for the sipper assembly 142 to access the interior 132 of the rigid or flexible container 124. The lid 128 may also be formed of or comprise a solid material such as rubber and/or an elastomer that is pierceable.

The sipper assembly 142 includes a reagent lumen 139 and a pressure lumen 141, which will be discussed further below. The sipper assembly 142 and/or the reagent lumen 139 may be referred to as a sipper. Once the sipper assembly 142 is inserted into the pressure and reagent port 138, a seal 150 is formed between the sipper assembly 142 and the lid 128. In some implementations, the seal 150 may comprise O-rings and/or may be include an elastomer, or combinations thereof.

During operation, the pressure source 106 delivers a pressurized fluid (such as an inert gas) to the interior 132 of the rigid or flexible container 124 through the pressure lumen 141. As the interior 132 of the rigid or flexible container 124 pressurizes, liquid (e.g., reagent) is forced up the reagent lumen 139. In other words, the reagent 118 in the rigid or flexible container 124 is aspirated up through the reagent lumen 139 by the increasing pressure in the interior 132 of the rigid or flexible container 124. Both the pressurizing of the interior 132 of the rigid or flexible container 124 and the aspiration of reagent 118 from the interior 132 of the rigid or flexible container 124 are accomplished simultaneously through the single pressure and reagent port 138 formed in the lid 128, which simplifies production and operation while limiting contamination access points. Additionally, the risk of reagent foaming is at least partially mitigated by having pressure directed into the headspace of the interior 132 of the rigid or flexible container 124, which at least partially prevents bubbling of the reagent. Further, because the risk of reagent foaming is mitigated, there is less risk of aspirating air bubbles through the fluidic channels, for example, to the flow cell. Finally, because the exit of the reagent lumen 139 and the exit of the pressure lumen 141 are separated from one another, the risk of the reagent lumen 139 aspirating fluid from the pressure lumen 141 is reduced.

The pressure source 106 may provide positive pressure to the interior of the rigid or flexible container 124. The pressure source 106 changes a pressure within the interior 132 of the rigid or flexible container 124 and that pressure change urges the reagent 118 out of the rigid or flexible container 124. All, a majority, or most of the reagent 118 may be dispensed from the rigid or flexible container 124 as a result and, thus, the reagent cartridges 102 disclosed have low amounts of dead volume.

In some implementations, the reagent cartridge 102 may also include a protective cover that protects the pressure and reagent port 138. The protective cover may be an impermeable barrier such as foil. The protective cover may prevent or inhibit contaminants from entering the container 124 and/or ingress of moisture into the interior 132 of the rigid or flexible container 124. The protective cover, in some implementations, may be a pierceable or removable cover including rubber, elastomer, a thin metal foil, such as aluminum foil, or a thin plastic sheet(s), such as Saran™ wrap. The protective cover may comprise other materials and/or other layering arrangements that substantially prevent moisture ingress. The protective cover may be coupled to the pressure and reagent port 138 by heat sealing, laser welding, ultrasonic welding, pressure-sensitive adhesive (PSA), or any other suitable method. The protective cover may alternatively be omitted in other implementations. A pierceable septum or resealing spring valve such as the lid 128 and/or the seal 150 may be included in place of or in addition to the protective cover, for example.

A regulator 160 can be positioned between the pressure source 106 and the reagent cartridge interface 108 and regulates a pressure provided to the reagent cartridge interface 108 and, thus, the interior 132 of the rigid or flexible container 124. The regulator 160 may alternatively not be included.

The reagent cartridge 102 is in fluid communication with the flow cell 104. A “flow cell” as used herein can include a device having a lid extending over a reaction structure to form a flow channel therebetween that is in communication with a plurality of reaction sites of the reaction structure, and can include a detection device that detects designated reactions that occur at or proximate to the reaction sites. The flow cell 104 is shown being received within a flow cell receptacle 162 of the system 100. The flow cell 104 may alternatively be carried by or otherwise integrated into the reagent cartridge 102.

The system 100 may optionally include a pump 164 positioned between the flow cell 104 and a waste reservoir 116. The waste reservoir 109 may be selectively receivable within a waste reservoir receptacle 165 of the system 100. The pump 164 may be implemented by a syringe pump, a peristaltic pump, a diaphragm pump, etc. While the pump 164 is shown being part of the system 100 and positioned between the flow cell 104 and the waste reservoir 116, the pump 164 may be positioned upstream of the flow cell 104, may be part of the reagent cartridge 102, or omitted entirely, in other implementations.

Referring now to the drive assembly 110, in the implementation shown, the drive assembly 110 includes a pump drive assembly 166 that interfaces with the pump 164 to pump fluid through the reagent cartridge 102 and/or the flow cell 104.

The controller 112 includes a user interface 168, a communication interface 170, one or more processors 172, and a memory 174 storing instructions executable by the one or more processors 172 to perform various functions including the disclosed implementations. The user interface 168, the communication interface 170, and the memory 174 are electrically and/or communicatively coupled to the one or more processors 172.

In an implementation, the user interface 168 receives input from a user and provides information to the user associated with the operation of the system 100 and/or an analysis taking place. The user interface 168 may include a touch screen, a display, a key board, a speaker(s), a mouse, a track ball, and/or a voice recognition system. The touch screen and/or the display may display a graphical user interface (GUI).

In an implementation, the communication interface 170 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 172 and/or the system 100 may include one or more of a processor-based system(s) or a microprocessor-based system(s). In some implementations, the one or more processors 172 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 174 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

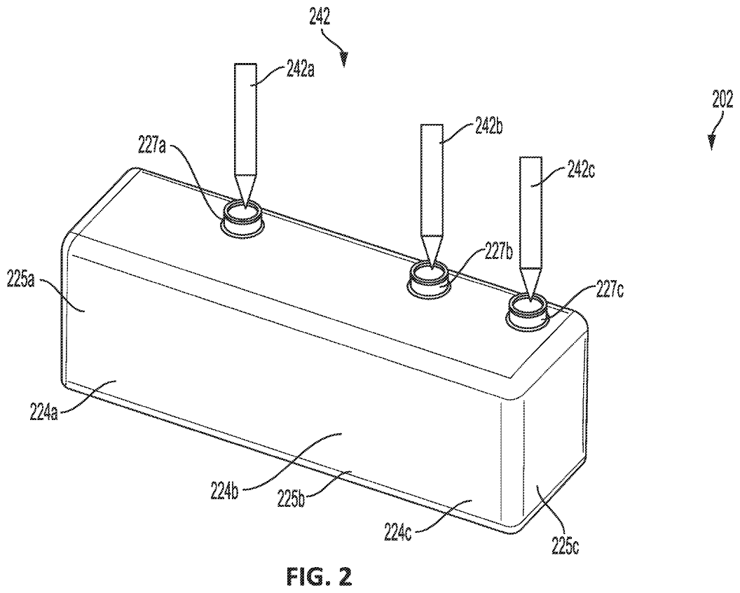

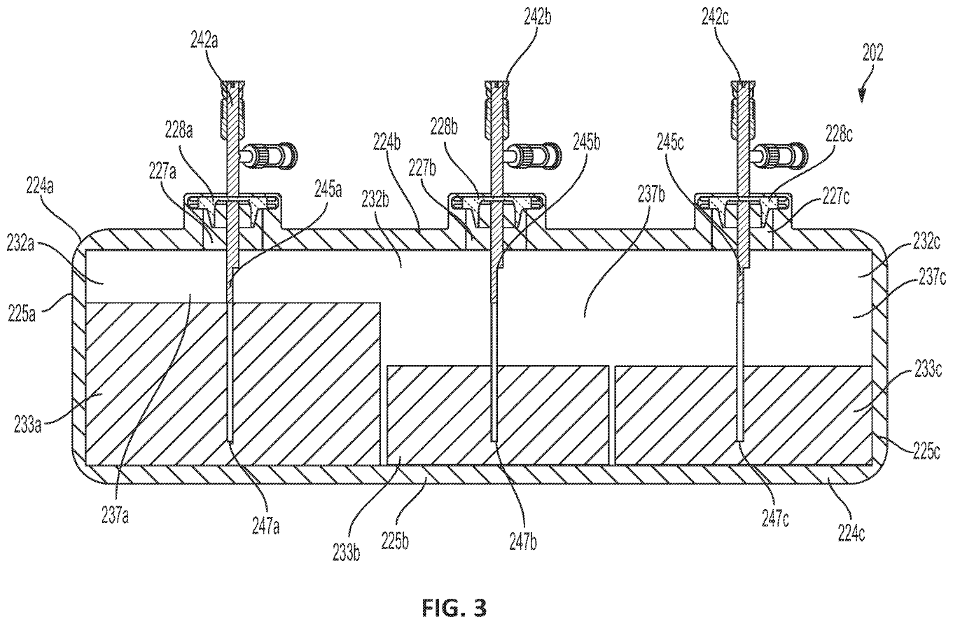

Turning now to FIGS. 2 and 3, a reagent cartridge assembly 202 is illustrated that may be incorporated into the system 100 of FIG. 1. The reagent cartridge assembly 202 includes a first rigid or flexible container 224a, a second rigid or flexible container 224b, and a third rigid or flexible container 224c. Each of the first, second, and third rigid or flexible containers 224 a, b, c, have a container body 225a, 225b, 225c, and an open end 227a, 227b, 227c, respectively. The container bodies 225a, 225b, 225c, each define an interior or reagent chamber 232a, 232b, 232c, respectively, that contain and/or are configured to contain a liquid reagent. A lid or cover 228a, 228b, 228c, is disposed over each of the open ends 227a, 227b, 227c, respectively. The lids 228a, 228b, 228c may be referred to as seals. The lids 228a, 228b, 228c may each be implemented by a septum or another type of cover. The reagent cartridge assembly 202 may be received in a receptacle, such as the reagent cartridge receptacle 105 of FIG. 1.

A sipper assembly 242 may include one or more individual sippers, for example three sippers 242a, 242b, 242c illustrated in FIGS. 2 and 3. The sippers 242a, 242b, 242c, are configured for piercing the cover and/or lid 128 to both pressurize the reagent chamber 232a, 232b, 232c, respectively, and to aspirate liquid reagent 233a, 233b, 233c, from the reagent chamber 232a, 232b, 232c. The reagent chambers 232a, 232b, 232c, include a headspace 237a, 237b, 237c for holding a fluid (e.g., a pressurized gas). The pressurized gas in the headspace 237a, 237b, 237c, forces reagent 233a, 233b, 233c up the sippers 242a, 242b, 242c and into a fluidic channel, for example the flow cell 104 (FIG. 1). In other implementations, the pressurized gas in the headspace 237a, 237b, 237c, forces reagent 233a, 233b, 233c up the sippers 242a, 242b, 242c and into a fluidic channel for dispensing into a container, for example, a well, as a part of a sample preparation process or nucleic acid library preparation process. Other implementations may include biological or chemical analysis processes.

The cover or lid 228a, 228b, 228c includes the pressure and reagent ports 238a, 238b, 238c fluidly coupled to the reagent chambers 232a, 232b, 232c, respectively. The sippers 242a, 242b, 242c pierce the lids 228a, 228b, 228c through the pressure and reagent ports 238a, 238b, 238c.

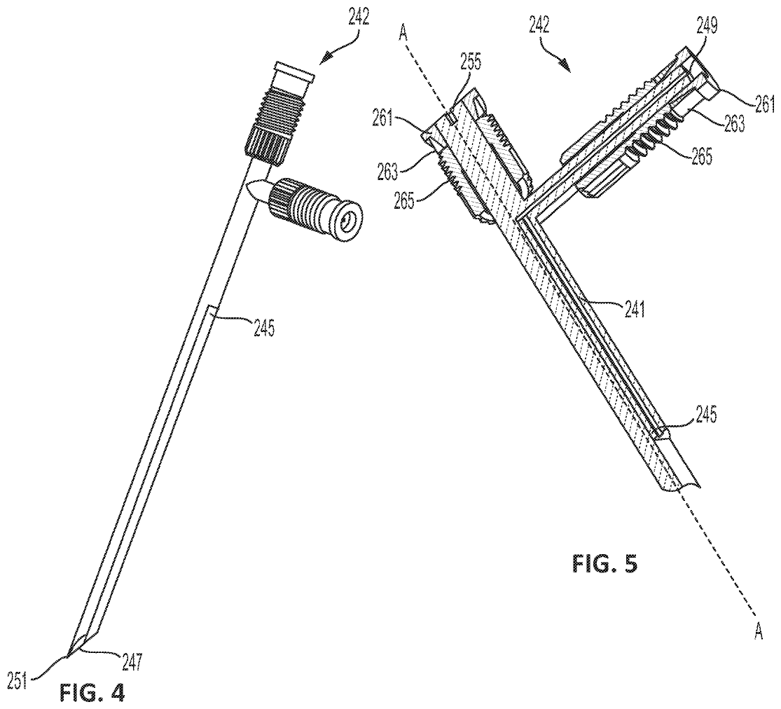

Turning now to FIGS. 4-6, the sipper assembly 242 is illustrated as a single sipper. The sipper assembly 242 of FIGS. 4-6 may be produced by injection molding. The sipper assembly 242 illustrated in FIGS. 4-6 is representative of any one of the sippers 242a, 242b, 242c, of FIGS. 2 and 3. The sipper assembly 242 includes a first or pressure lumen 241 and a second or reagent lumen 239. The first lumen 241 is configured to deliver pressurized fluid (e.g., an inert gas or air) to the reagent chamber 232 (FIG. 3) and the second lumen 239 is configured to aspirate liquid reagent 233 from the reagent chamber 232 (FIG. 3). The first lumen 241 is fluidly connected to the source of pressurized fluid 106 (FIG. 1) and the second lumen 239 has a reagent outlet 255 that is fluidly connected to the flow cell 104 (FIG. 1).

The first lumen 241 has a pressurization exit 245 and the second lumen 239 has an aspiration inlet 247. The pressurization exit 245 is located above a level of liquid reagent 233 in the reagent chamber 232 (FIG. 3) and the aspiration inlet 247 is located proximate a bottom of the reagent chamber 232, when the sipper assembly 242 is completely inserted into the container body 225 through the cover 228 (FIG. 3). The pressurization exit 24 may thus be positioned within a headspace 237 of the reagent chamber 232.

The first lumen 241 includes a pressurization inlet 249 that is connected to the source of pressurized fluid 106. The pressurized fluid may be inert gas or air. The pressurization inlet 249 may be connected to the source of pressurized fluid 106 with a ferrule 261, a collar 263, and a nut 265. The nut 265 is shown including threads. In other implementations, other types of connections may be used. In some implementations, the first lumen 241 includes an approximately 90 degree bend between the pressurization inlet 249 and the pressurization exit 245, as illustrated in FIGS. 4-6. In some implementations, the first lumen 241 is shorter than the second lumen 239. In one implementation, the first lumen 241 may be limited to about 20% of the sipper assembly 242 length, while the second lumen 239 may be at least 80% of the length of the sipper assembly 242. In other implementations, an exit of the first lumen 241 may be located in the upper 10% of the sipper assembly 242 length, while an exit of the second lumen 239 may be located in the bottom 10% of the sipper assembly 242 length. Configured as such, the pressurized fluid may be directed into the headspace 237 of the reagent chamber 232, which reduces foaming and/or gas aspiration. The sipper assembly 242 may include a chamfered distal end 251 to help pierce the cover or lid 228. The distal end 251 may additionally or alternatively be pointed and/or include a tip. In the implementation illustrated in FIGS. 4-6, the aspiration inlet 247 is located proximate the chamfered distal end 251.

As illustrated in FIG. 5, the pressurization exit 245 is substantially perpendicular to a longitudinal axis A of the sipper assembly 242. In other implementations, the pressurization exit 245 may be substantially parallel to the longitudinal axis A of the sipper assembly 242.

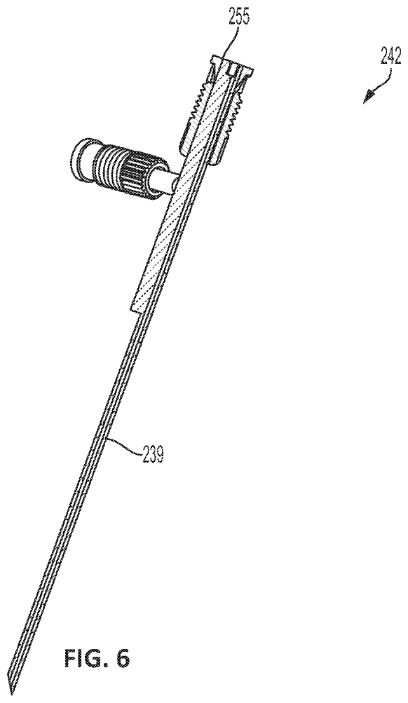

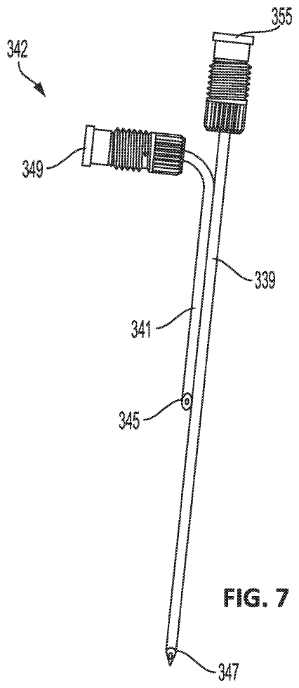

FIG. 7 illustrates an alternate implementation of a sipper assembly 342 that is shown implemented by a single sipper. Similar to the implementation of FIGS. 4-6, the sipper assembly 342 includes a first or pressurizing lumen 341 and a second or reagent lumen 339. The difference in the implementation of FIG. 6 is that each of the first and second lumens 341, 339 are formed as individual tubes that are joined to one another to form an integral structure. The sipper assembly 342 includes an aspiration inlet 347 and an aspiration outlet 355. The sipper assembly 342 also includes a pressurization inlet 349 and a pressurization outlet 345. The pressurization outlet 345 may also be referred to as a pressurization exit.

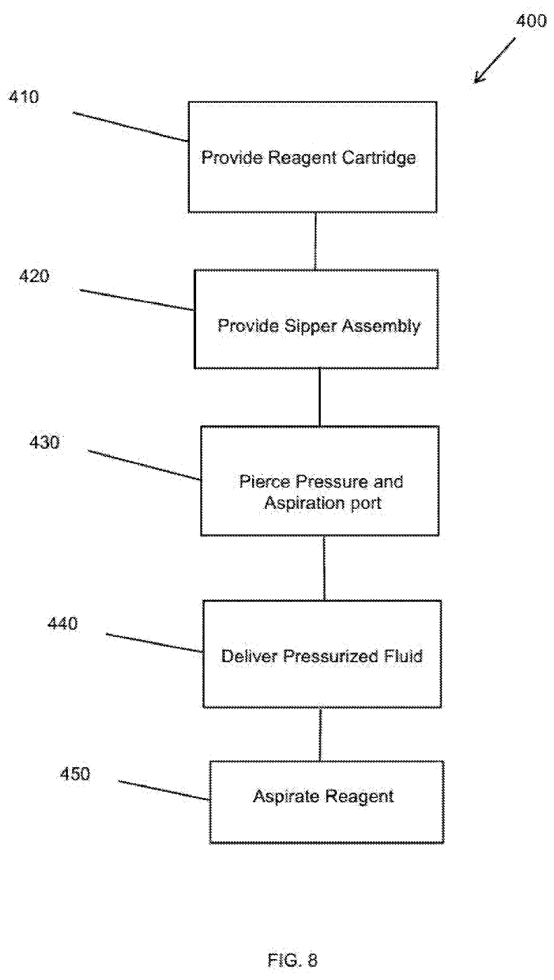

Turning now to FIG. 8, a method 400 of both pressurizing and aspirating a reagent chamber is illustrated. Initially, a reagent cartridge is provided at 410 that has a reagent chamber and a pressure and aspiration port. The reagent cartridge 410 may take the form of the reagent cartridge 102 of FIG. 1 or the reagent cartridge assembly 202 of FIGS. 2 and 3. A sipper assembly is provided at 420 that includes a first lumen and a second lumen. The sipper assembly may take the form of the sipper or sipper assembly 142, 242, 342 of FIGS. 1-7. The pressure and aspiration port of the reagent cartridge is pierced at 430 with the sipper assembly. A pressurized fluid is delivered to the reagent chamber through the first lumen at 440 and liquid reagent is aspirated from the reagent chamber through the second lumen at 450.

Example 1. An apparatus, comprising: a reagent cartridge including a first container having a container body and an open end, the container body defining reagent chamber containing a liquid reagent, and a cover disposed over the open end; and a system, comprising: a receptacle to receive the reagent cartridge; and a sipper assembly for piercing the cover of the reagent cartridge to both pressurize the reagent chamber and to aspirate liquid reagent from the reagent chamber; wherein the sipper assembly includes a first lumen and a second lumen, the first lumen delivering pressurized fluid to the reagent chamber and the second lumen aspirating liquid reagent from the reagent chamber.

Example 2. The apparatus of example 1, wherein the cover includes a pressure and reagent port fluidly coupled to the reagent chamber and the sipper assembly pierces the cover through the pressure and reagent port.

Example 3. The apparatus of example 1 or example 2, further comprising a source of pressurized fluid and wherein the first lumen is fluidly connected to the source of pressurized fluid.

Example 4. The apparatus of any one of the preceding examples, wherein the first lumen is shorter than the second lumen.

Example 5. The apparatus of any one of the preceding examples, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into the container body through the cover.

Example 6. The apparatus of any one of the preceding examples, wherein the first lumen includes a pressurization inlet, and the first lumen includes an approximately 90 degree bend between the pressurization inlet and the pressurization exit.

Example 7. The apparatus of any one of preceding examples, wherein the sipper assembly includes a chamfered distal end.

Example 8. The apparatus of example 7, wherein the aspiration inlet is located proximate the chamfered distal end.

Example 9. The apparatus of any one of the proceeding examples, wherein the cover comprises foil.

Example 10. The apparatus of any one of the proceeding examples, wherein the cover comprises a septum.

Example 11. The apparatus of any one of the proceeding examples, wherein the pressurization exit is substantially perpendicular to a longitudinal axis of the sipper assembly.

Example 12. The apparatus of any one of the preceding examples, wherein the pressurization exit is substantially parallel to a longitudinal axis of the sipper assembly.

Example 13. The apparatus of any one of the preceding examples, further comprising a reagent fluid disposed in the reagent chamber.

Example 14. The apparatus of any one of the preceding examples, further comprising a fluidic interface fluidly connected to the sipper assembly and adapted to be fluidly coupled to a flow cell.

Example 15. An apparatus, comprising: a receptacle to receive a reagent cartridge; and a sipper assembly for piercing a cover of the reagent cartridge to both pressurize a reagent chamber and to aspirate liquid reagent from the reagent chamber; wherein the sipper assembly includes a first lumen and a second lumen, the first lumen delivering pressurized fluid to the reagent chamber and the second lumen aspirating liquid reagent from the reagent chamber.

Example 16. The apparatus of example 15, wherein the first lumen is fluidly connected to a source of pressurized fluid.

Example 17. The apparatus of any one of examples 15 or 16, wherein the first lumen is shorter than the second lumen.

Example 18. The apparatus of any one of examples 15-17, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into a container body through the cover.

Example 19. The apparatus of any one of examples 15-18, wherein the first lumen includes a pressurization inlet, and the first lumen includes an approximately 90 degree bend between the pressurization inlet and the pressurization exit.

Example 20. A method, comprising: piercing a pressure and aspiration port of a reagent cartridge with a sipper assembly, where the sipper assembly includes a first lumen and a second lumen; delivering a pressurized fluid to a reagent chamber through the first lumen; and aspirating liquid reagent from the reagent chamber through the second lumen.

Example 21. The method of example 20, wherein delivering the pressurized fluid to the reagent chamber through the first lumen comprises delivering gas to the reagent chamber through the first lumen.

Example 22. The method of any one of examples 20-21 wherein delivering the pressurized fluid to the reagent chamber through the first lumen comprises delivering gas to the reagent chamber through the first lumen within a headspace of the reagent cartridge.

Example 23. The method of any one of examples 20-22, wherein the first lumen and the second lumen are integral.

Example 24. The method of any one of examples 20-23, wherein the first lumen has a first opening and second lumen has an opening, and wherein piercing the pressure and aspiration port of the reagent cartridge with the sipper assembly comprises positioning the first opening of the first lumen within a headspace of the reagent chamber and comprises positioning the second opening of the second lumen within the liquid reagent.

Example 25. An apparatus, comprising: a sipper assembly comprising a first lumen and a second lumen, wherein the first lumen is to deliver pressurized fluid to a chamber and the second lumen is to aspirate liquid from the chamber.

Example 26. The apparatus of example 25, wherein the first lumen has an opening and the second lumen has an opening, the opening of the first lumen to be positioned within a headspace of a container, the opening of the second lumen to be positioned within the liquid.

Example 27. A method, comprising: piercing a pressure and aspiration port of a reagent chamber of a reagent cartridge with a sipper assembly, where the sipper assembly includes a first lumen and a second lumen; delivering a pressurized fluid to the reagent chamber of the reagent cartridge through the first lumen, where the first lumen has a pressurization exit, the pressurization exit being located above a level of liquid reagent in the reagent chamber; and aspirating liquid reagent from the reagent chamber through the second lumen, where the second lumen has an aspiration inlet, the aspiration inlet being located below the level of liquid reagent in the reagent chamber.

Example 28. The method of example 27, wherein delivering the pressurized fluid to the reagent chamber through the first lumen comprises delivering air to the reagent chamber through the first lumen.

Example 29. The method of example 27, wherein delivering the pressurized fluid to the reagent chamber through the first lumen comprises delivering inert gas to the reagent chamber through the first lumen.

Example 30. The apparatus of example 1, wherein the first lumen is shorter than the second lumen.

Example 31. The apparatus of example 1, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into a container body through the cover.

Example 32. The apparatus of example 1, wherein the first lumen includes a pressurization inlet, and the first lumen includes an approximately 90 degree bend between the pressurization inlet and the pressurization exit.

Example 33. The apparatus of example 1, wherein the pressurization exit is substantially perpendicular to a longitudinal axis of the sipper assembly.

Example 34. The apparatus of example 1, wherein the pressurization exit is substantially parallel to a longitudinal axis of the sipper assembly.

Example 35. The apparatus of example 1, further comprising a fluidic interface fluidly connected to the sipper assembly and adapted to be fluidly coupled to a flow cell.

Example 36. The apparatus of example 15, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into the container body through the cover.

Example 37. The apparatus of example 15, wherein the first lumen includes a pressurization inlet, and the first lumen includes an approximately 90 degree bend between the pressurization inlet and the pressurization exit.

Example 38. The method of example 20, wherein the first lumen and the second lumen are integral.

Example 39. The method of example 20, wherein the first lumen has a first opening and second lumen has an opening, and wherein piercing the pressure and aspiration port of the reagent cartridge with the sipper assembly comprises positioning the first opening of the first lumen within a headspace of the reagent chamber and comprises positioning the second opening of the second lumen within the liquid reagent.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “substantially,” “approximately,” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a reagent cartridge including a first container having a container body and an open end, the container body defining a reagent chamber containing a liquid reagent, and a cover disposed over the open end; and
a system, comprising:
a receptacle to receive the reagent cartridge; and
a sipper assembly for piercing the cover of the reagent cartridge to both pressurize the reagent chamber and to aspirate liquid reagent from the reagent chamber;
wherein the sipper assembly includes a first lumen and a second lumen, the first lumen delivering pressurized fluid to the reagent chamber and the second lumen aspirating liquid reagent from the reagent chamber.

2. The apparatus of claim 1, wherein the cover includes a pressure and reagent port fluidly coupled to the reagent chamber and the sipper assembly pierces the cover through the pressure and reagent port.

3. The apparatus of claim 1, further comprising a source of pressurized fluid and wherein the first lumen is fluidly connected to the source of pressurized fluid.

4. The apparatus of claim 1, wherein the first lumen is shorter than the second lumen.

5. The apparatus of claim 1, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into the container body through the cover.

6. The apparatus of claim 1, wherein the first lumen includes a pressurization inlet, and the first lumen includes an approximately 90 degree bend between the pressurization inlet and the pressurization exit.

7. The apparatus of claim 1, wherein the sipper assembly includes a chamfered distal end.

8. The apparatus of claim 7, wherein the aspiration inlet is located proximate the chamfered distal end.

9-10. (canceled)

11. The apparatus of claim 1, wherein a pressurization exit is substantially perpendicular to a longitudinal axis of the sipper assembly.

12. The apparatus of claim 1, wherein a pressurization exit is substantially parallel to a longitudinal axis of the sipper assembly.

13. The apparatus of claim 1, further comprising a reagent fluid disposed in the reagent chamber.

14. The apparatus of claim 1, further comprising a fluidic interface fluidly connected to the sipper assembly and adapted to be fluidly coupled to a flow cell.

15. An apparatus, comprising:
a receptacle to receive a reagent cartridge; and
a sipper assembly for piercing a cover of the reagent cartridge to both pressurize a reagent chamber and to aspirate liquid reagent from the reagent chamber;
wherein the sipper assembly includes a first lumen and a second lumen, the first lumen delivering pressurized fluid to the reagent chamber and the second lumen aspirating liquid reagent from the reagent chamber.

16. The apparatus of claim 15, wherein the first lumen is fluidly connected to a source of pressurized fluid.

17. The apparatus of claim 15, wherein the first lumen is shorter than the second lumen.

18. The apparatus of claim 15, wherein the first lumen has a pressurization exit and the second lumen has an aspiration inlet, the pressurization exit being located above a level of liquid reagent in the reagent chamber and the aspiration inlet being located proximate a bottom of the reagent chamber, when the sipper assembly is completely inserted into a container body through the cover.

19. The apparatus of claim 15, wherein the first lumen includes a pressurization inlet, and the first lumen includes an approximately 90 degree bend between the pressurization inlet and the pressurization exit.

20-26. (canceled)

27. A method, comprising:
piercing a pressure and aspiration port of a reagent chamber of a reagent cartridge with a sipper assembly, where the sipper assembly includes a first lumen and a second lumen;
delivering a pressurized fluid to the reagent chamber of the reagent cartridge through the first lumen, where the first lumen has a pressurization exit, the pressurization exit being located above a level of liquid reagent in the reagent chamber; and
aspirating liquid reagent from the reagent chamber through the second lumen, where the second lumen has an aspiration inlet, the aspiration inlet being located below the level of liquid reagent in the reagent chamber.

28. The method of claim 27, wherein delivering the pressurized fluid to the reagent chamber through the first lumen comprises delivering air to the reagent chamber through the first lumen.

29. The method of claim 27, wherein delivering the pressurized fluid to the reagent chamber through the first lumen comprises delivering inert gas to the reagent chamber through the first lumen.

30-39. (canceled)
